(19) United States
(12) Patent Application Publication
(10) Pub. No.: US 2023/0201859 A1
(43) Pub. Date: Jun. 29, 2023

(54) Automatic wood flooring boards reparation device and method thereof

(71) Applicant: Les Bois de Plancher P.G. inc., Saint-Edouard-de-Lotbiniere (CA)

(72) Inventors: Olivier Garneau, Saint-Edouard-de-Lotbiniere (CA); Claude Garneau, Saint-Edouard-de-Lotbiniere (CA); Sylvain Belanger, Saint-Edouard-de-Lotbiniere (CA); Patrice Faucher, Sainte-Marie-de-Beauce (CA); Richard Audet, Sainte-Marie-de-Beauce (CA)

(21) Appl. No.: 18/146,197

(22) Filed: Dec. 23, 2022

Related U.S. Application Data
(60) Provisional application No. 63/265,957, filed on Dec. 23, 2021.

(51) Int. Cl. B05C 5/02; B05C 13/02; E04F 15/18

(52) U.S. Cl. CPC B05C 5/0208; B05C 13/02; E04F 15/18

(57) ABSTRACT

An automatic wood flooring boards reparation device for applying and spreading filler over boards is provided, the device comprising an infeed unit, an outfeed unit and a filler applicator. The filler applicator applies filler over a top surface of the boards with a head comprising a main body, a spreading device and a bottom portion, each part comprising an opening for distributing filler over the board and an opening for securing a scrapper for spreading the applied filler. A tight seal is created between a filler applicator opening of the bottom portion and the top surface of the boards to avoid overspill of filler. A method for applying filler is also provided.

### CROSS-REFERENCE TO RELATED APPLICATIONS

The present patent application claims the benefits of priority of U.S. Provisional Patent Application No. 63/265,957, entitled “Automatic wood flooring boards reparation device and method thereof”, and filed at the United States Patent and Trademark Office on Dec. 23, 2021, the content of which is incorporated herein by reference.

### FIELD OF THE INVENTION

The present invention generally relates to devices and methods for automatically repairing wood flooring boards, such as boards comprising cracks, knots or other defects. More specifically, the present invention may relate to automatic repair of defects in wood flooring boards using a filler, such as putty.

### BACKGROUND OF THE INVENTION

Wood flooring boards or planks are used to provide a covering to a floor that is solid yet aesthetically and visually pleasant. As such, during manufacturing process of the wood flooring boards, the boards undergo a process to repair or at least lessen imperfections or defects present on the plank surface.

In such process, wood putty is manually applied over holes, cracks or other defects present on the surface of the planks. The application of putty levels the top surface of the plank prior to being sandblasted and varnished. Thus, the resulting plank is visually appealing and has an increased longevity.

As described above, the application of putty is manually performed, thus requiring workers to manually apply using a trowel, a spray gun and/or a brush, depending on the viscosity of the filler. When brushes are used with more viscous finishes such as putty, it may be hard for a worker to evenly spread the filler over the defects to provide a flat top surface of the plank and to sufficiently fill the entirety of the defects. This manual process is time-consuming and may only allow a maximal speed to ensure a minimum level of quality. Furthermore, training new workers and making sure that the trained workers show up may be quite time consuming for managers.

Another method known in the art provides an apparatus for adding glue around all the outer surfaces of a wall base board. Such apparatus comprises a conveyor and a glue applicator. The glue applicator is shaped as the outer surfaces of the base board and comprises an opening shaped as the cross-section of the baseboard. Such apparatus may not be used with flooring wood planks as the planks have dimensions that vary from one plank to the other. As such, when planks are narrower, the excess of glue accumulates and blocks movement of the plank within the glue applicator.

Hence, there is a need for processing equipment and method to automatically and continuously repair defects present on wood floor planks' top surface.

### SUMMARY OF THE INVENTION

The shortcomings of the prior art are generally mitigated with an automatic wood boards reparation system, comprising a filler applicator to be pressed against a top surface of a wood board being conveyed, the filler applicator being in fluid communication with a source of pressurized filler to create a sealed chamber between the top surface of the wood board and a bottom portion of the filler applicator, the filler applicator comprising an opening to spread a layer of the pressurized filler on the top surface of the wood board and a conveying system to move the wood board toward and away from the filler applicator.

In an aspect of the invention, the system may comprise a leveling system to maintain the processed wood board leveled with the bottom portion of the filler applicator. The leveling system may comprise a top roller rotatable over the top surface of the board. The leveling system may further comprise a slider to maintain the top surface of the board leveled with the bottom portion of the filler applicator.

In an aspect of the invention, the conveying system may comprise a board displacement system limiting gaps between extremities of wood boards fed to the filler applicator. The board displacement system may comprise at least two pairs of laterally opposing wheels adapted to contact sidewalls of the wood boards to be processed, the upstream pair of wheels being configured to drive a first wood board toward a second wood board immobilized by the downstream pair of wheels. One of each of the at least two pairs of laterally opposing wheels may comprise a drive wheel. The wheels may comprise a friction surface in contact with sidewards of the wood boards. The friction surface may be a gripping surface. The gripping surface may comprise a plurality of screw heads.

In an aspect of the invention, the conveying system may comprise a width adjustment system. The width adjustment system may comprise a side portion comprising a side wall laterally movable toward a fixed portion comprising a side wall.

In an aspect of the invention, the conveying system may comprise a height adjustment system. The height adjustment system may have the wheels being treaded and attached to a base surface, the wheels being configured to change in height when screwed or unscrewed.

In an aspect of the invention, the system may comprise a second filler applicator having a different width than the first filler applicator.

In an aspect of the invention, the system may further comprise a pressure application system adapted to apply pressure on the filler applicator against the top surface of the wood board. The pressure application system may comprise a cylinder at each corner of a top portion of the filler applicator to apply a constant pressure over the top surface of the wood board.

In an aspect of the invention, the system may comprise a plurality of sensors connected to a controller for detecting presence of wood board, the controller being configure to feed the wood board based on signals of the sensors.

A method for repairing a top surface of wood boards may further be provided, the method comprising conveying the wood board, pressing a filler applicator against the top surface of the wood board being conveyed and spreading a layer of pressurized filler over the top surface of the wood board through an aperture of a bottom surface of the filler applicator. The method may further comprise maintaining the conveyed wood board leveled with the bottom portion of the filler applicator. The method may further comprise closing gaps between two extremities of conveyed wood boards. The method may further comprise applying pressure at different locations on a top portion of the filler applicator to maintain a constant pressure of the filler applicator over the top surface of the conveyed wood boards.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1A is a perspective view of an automatic wood flooring boards reparation device in accordance with the principles of the present invention.

FIG. 1B is another perspective view of the automatic wood flooring boards reparation device of FIG. 1A.

FIG. 1C is a perspective view of a pressuring mechanism of the automatic wood flooring boards reparation device of FIG. 1A.

FIG. 2 is a perspective view of an infeed portion of the automatic wood flooring boards reparation device of FIG. 1A.

FIG. 3 is an illustration of an outfeed portion of the automatic wood flooring boards reparation device of FIG. 1A.

FIG. 4 is an exploded view of an embodiment of a head of a filler applicator of an automatic wood flooring boards reparation device in accordance with the principles of the present invention.

FIG. 5A is perspective view of a main body of an embodiment of the head of the filler applicator of an automatic wood flooring boards reparation device in accordance with the principles of the present invention.

FIG. 5B is a side sectional view of the head of the filler applicator of FIG. 5A.

FIG. 6A is perspective view of an embodiment of a spreading device of the head of a filler applicator of an automatic wood flooring boards reparation device in accordance with the principles of the present invention.

FIG. 6B is a side sectional view oft the spreading device of FIG. 6A.

FIG. 7 is a perspective view of an embodiment of a bottom portion of the head of a filler applicator of an automatic wood flooring boards reparation device in accordance with the principles of the present invention.

FIG. 8 is a perspective view of an embodiment of a securing pin of the head of a filler applicator of an automatic wood flooring boards reparation device in accordance with the principles of the present invention.

FIG. 9 is a perspective view of an embodiment of a scrapper of the head of a filler applicator of an automatic wood flooring boards reparation device in accordance with the principles of the present invention.

FIG. 10 is a perspective view of a second embodiment of a spreading device of the head of a filler applicator of an automatic wood flooring boards reparation device in accordance with the principles of the present invention.

FIG. 11 is a perspective view of a second embodiment of a bottom portion of the head of a filler applicator of an automatic wood flooring boards reparation device in accordance with the principles of the present invention.

FIG. 12 is a perspective view of a pressurized filler distribution system of an automatic wood flooring boards reparation device in accordance with the principles of the present invention.

FIG. 13 is a perspective view of an embodiment of a filler refilling station for an automatic wood flooring boards reparation device in accordance with the principles of the present invention.

FIG. 14 is a perspective view of an embodiment of a control system of an automatic wood flooring boards reparation device in accordance with the principles of the present invention.

FIG. 15 is a perspective view of a plurality of automatic wood flooring boards reparation devices in accordance with the principles of the present invention.

FIG. 16 is a perspective view of another embodiment of a plurality of automatic wood flooring boards reparation devices in accordance with the principles of the present invention.

FIG. 17 is a top view of the plurality of automatic wood flooring boards reparation devices of FIG. 16.

FIG. 18 is a side view of the plurality of automatic wood flooring boards reparation devices of FIG. 16.

FIG. 19 a rear perspective view of the plurality of automatic wood flooring boards reparation devices of FIG. 16.

FIG. 20 an embodiment of a plurality of automatic wood flooring boards reparation devices with covers in accordance with the principles of the present invention.

FIG. 21 a perspective view of an embodiment of an automatic wood flooring boards reparation devices in accordance with the principles of the present invention.

FIG. 22 a top view of an embodiment of an automatic wood flooring boards reparation devices in accordance with the principles of the present invention.

FIG. 23 a perspective view of an actuated wheel in accordance with the principles of the present invention.

### DETAILED DESCRIPTION OF THE INVENTION

A novel automatic wood flooring boards reparation device and method thereof will be described hereinafter. Although the invention is described in terms of specific illustrative embodiments, it is to be understood that the embodiments described herein are by way of example only and that the scope of the invention is not intended to be limited thereby.

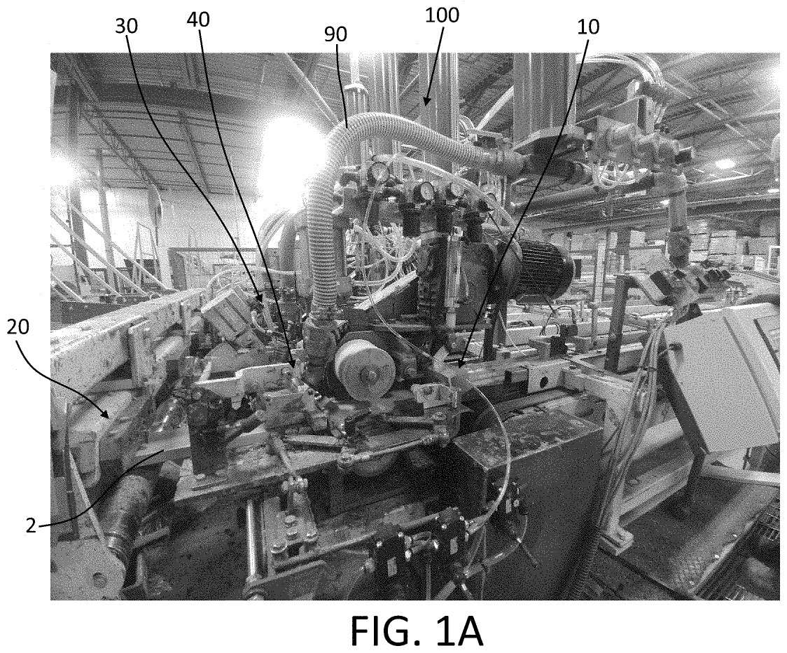

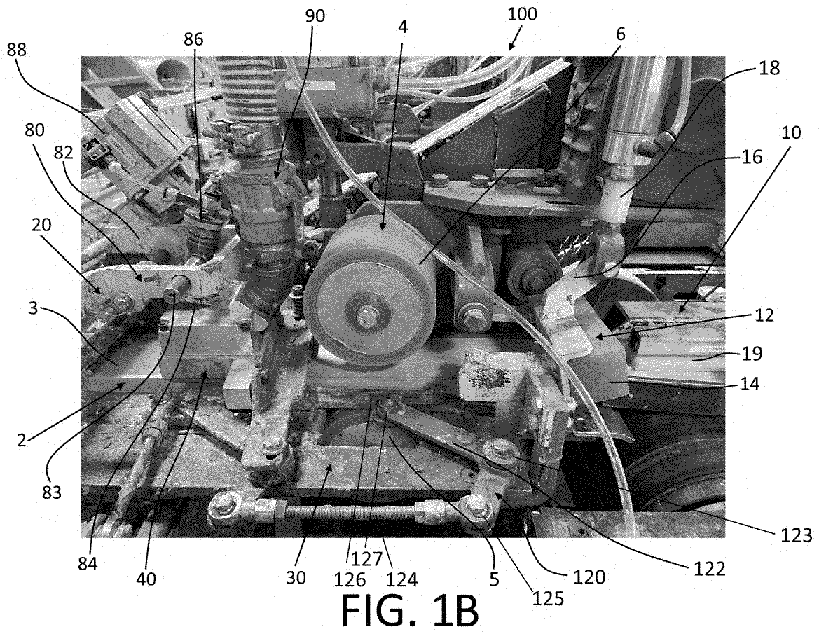

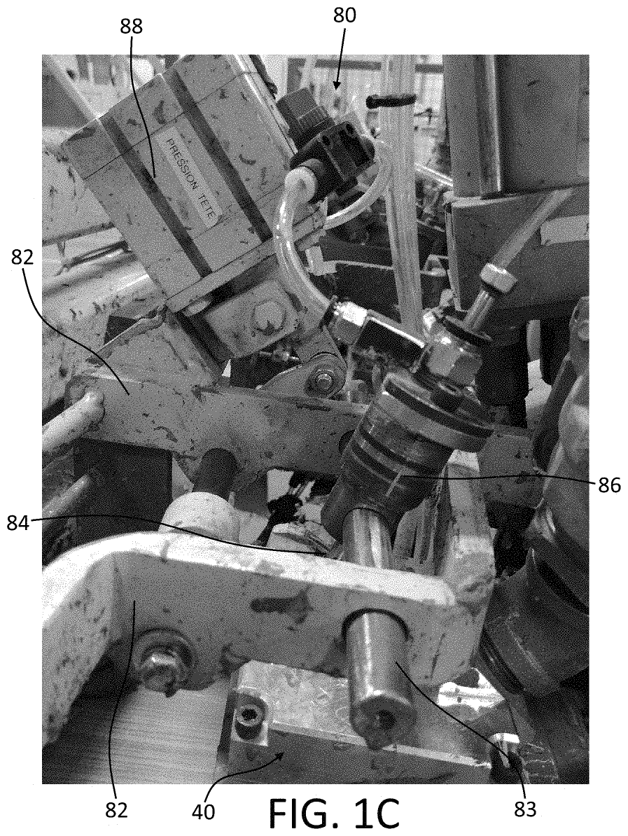

Referring to FIGS. 1A to 1C, an automatic wood flooring boards reparation device 100 is shown. Broadly, the device 100 receives one or more boards 2, such as but not limited to wooden planks such as hardwood flooring boards. The device 100 automatically and evenly applies a pressurized filler, such as but not limited to putty, on a top surface of the processed board as the board is conveyed. Understandably, the board 2 may be replaced with any other objects having a flat top surface. As such, the material of the planks is not limited to wood. As such, the material may be any substantially solid material or composition of materials. It may further be understood that the filler may have different viscosities, such as having a consistency similar to paste or a semi-liquid/liquid.

In some embodiments, the device 100 comprises an infeed portion 10, an outfeed portion 20 and a filler applicator 30. The filler applicator 30 is typically fed with boards 2 from the infeed portion 10 and outputs the processed boards 2 toward the outfeed 20 portion.

The device 100 typically comprises a conveying system 4 for displacing the boards 2 through the filler applicator 30. The conveying system 4 may be embodied as any type of conveying means know in the art, such as but not limited to an endless band conveyor.

In the illustrated embodiment of FIGS. 1A and 1B, the conveying system 4 comprises a bottom roller 5 and a top roller 6 movable between a “contacting” position and a “release” position. The rollers 5 and 6 illustrated in FIG. 1B are shown in the “release” position. When the rollers 5, 6 are activated and are contacting the top and bottom surfaces of the planks 2, the planks 2 are displaced due to friction with the outer surface of the rollers 5, 6. In the illustrated embodiment, the conveying system 4 comprises an actuator, not shown, controlled by a servomotor. The actuator is operatively connected to the rollers 5, 6. The actuator moves the rollers 5, 6 one toward the other or one away from the other. The servomotor may be in data communication with one or more sensors to detect the presence of a plank 2 to be processed. When the presence is detected, the servomotor sends a signal to the actuator to move the roller 5, 6 one toward the other and to activate rotation of the rollers 5, 6. As a consequence, the board 2 is moved toward the outfeed portion 20 while the filler applicator 30 applies filler over the top surface of the board 2.

Understandably, any other mechanism increasing friction against the top and bottom surfaces of the plank 2 may be used in the illustrated embodiment, such as a mechanism comprising more or less than two rollers 5, 6. The illustrated conveying system 4 is positioned at the filler applicator 30 but could be positioned at the infeed section 10 and/or at the outfeed section 20 and/or a combination thereof.

In some embodiments, the device 100 may comprise an infeed section 10 adapted to convey the unprocessed boards 2 toward the filler applicator 30. In the illustrated embodiment, the boards 2 are conveyed to the filler applicator 30 in series, such as that each board 2 is conveyed after another of the boards 2. Understandably, any mean to feed the unprocessed boards 2 may be used within the scope of the present invention. Preferably, the infeed portion 10 is connected in continuation with the conveying system 4 of the device 100. As such, the boards 2 being displaced on the conveying system 4 of the infeed section 10 are substantially or fully contacting with one another at their lengthwise extremities.

The device 100 may receive boards 2 having a varied range of dimensions, such as but not limited to widths of 2″, 3″, 4″ or 5″ or 2¼″ or of 3¼″, 4¼″ or 5¼″. During a production of a specific width of boards, each board 2 may have a width slightly varying from one another, such as width varying by 0.075″. Understandably, the tolerance may be greater or lower than 0.075″. The present device 10 advantageously allows repairing boards 2 having dimensions varying from one board to the other, thus allowing the repair process to be part of a continuous production process.

Still referring to FIG. 1B, the device 10 may comprise a width adjusting mechanism 120 adapted to adjust the device 10 to different widths of boards 2. In the illustrated embodiment, the width adjusting mechanism 120 comprises a pivot arm 122, a width locker 124 and a board push member 126. In the present embodiment, the pivot arm 122 is pivotally attached to the frame of the device 100 at a pivot point 123. A first end 125 of the pivot arm 122 is attached to the width locker 124 and a second end 127 of the pivot arm 122 is pivotally attached to the board push member 126. The width locker 124 generally allows to lock the board push member 126 to a specific width. In some embodiments, the width locker may be embodied as a length adjustable rod. The board push member 126 creates a fence to maintain alignment of the processed board 2. The board push member 26 presses on the sides of the boards 2 to align them with the output of the filler applicator 30. In other embodiments, the adjusting mechanism may comprise an actuator adapted to control the movement of the pivot arm 122. In further embodiment, the adjusting mechanism 120 may comprise a servomotor in data communication with one or more sensors to detect the presence of a plank 2 or to detect width of the board 2 to be processed. Understandably, any other means to adjust to the width of the processed board 2 may be used within the scope of the present invention.

The infeed section 10 may further comprise a stopper or stopping mechanism 12 as shown at FIG. 1B. In the illustrated embodiment, the stopping mechanism 12 comprises a block 14, a pivot link 16 and an actuator 18. The actuator 18 move the pivot link 16 up and down thus pressing the block 14 against the top surface 3 of a plank 2 or in front of the extremity of the plank 2 to stop movement of the said board 2. Understandably, any other stopping mechanism known in the art may be used with the present invention, such as but not limited to gates, doors, presser, etc.

The stopper 12 further acts as a means to maintain a pressure on the top surface of the boards 2 while being processed. As such, when the filler applicator 30 presses on the top surface of the board 2, the board 2 is leveled along its length.

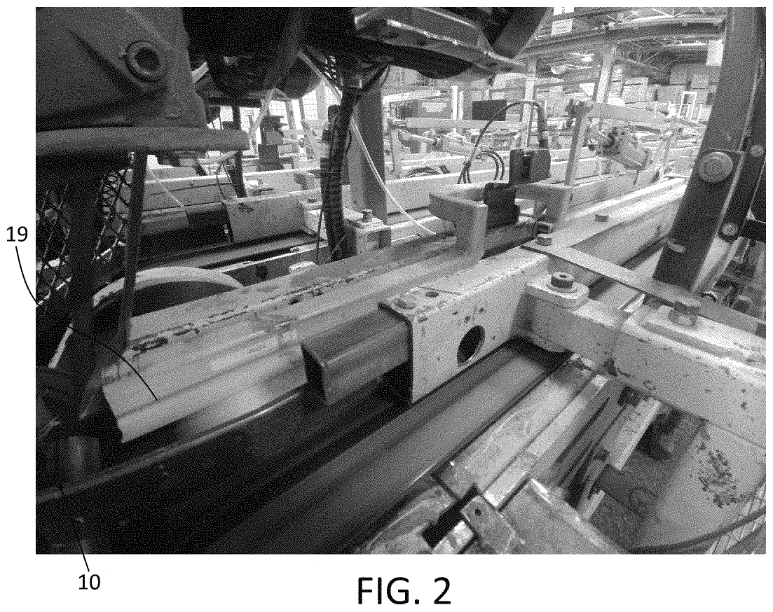

Referring to FIGS. 1B and 2, the device 100 may further comprise a board stabilizer, such as a slider 19. The board stabilizer generally aims at leveling the board 2 to enter the infeed section 10. The board stabilizer may comprise a slider 19 attached to a longitudinal member over the inbound conveyor. The slider 19 is generally made of a material gliding over the top surface 3 of the board 2 while not damaging the said surface 3. As such, the slider 19 may be made of low friction plastic or any other low friction yet solid material.

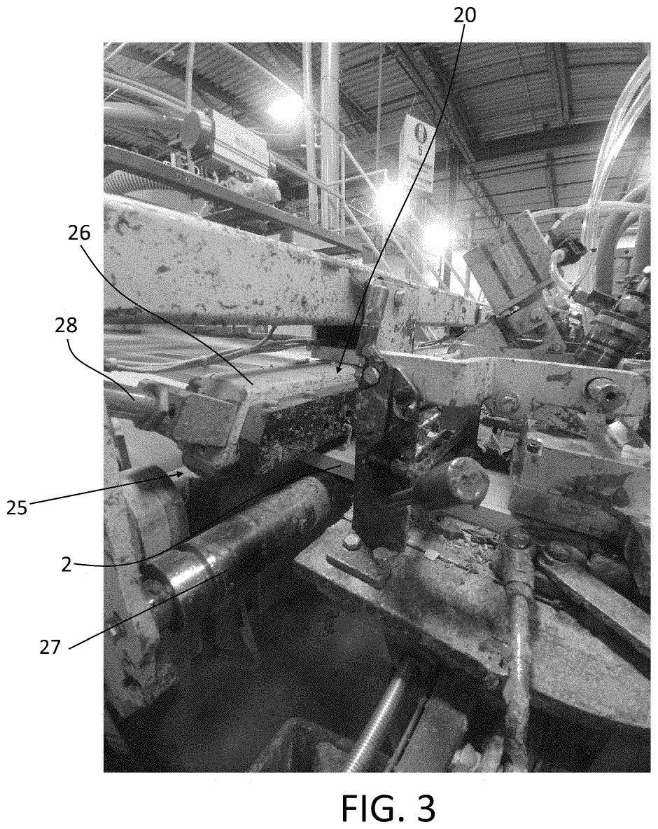

Referring now to FIG. 3, an embodiment of an outfeed unit or portion 20 is illustrated. The outfeed unit 20 generally comprises a stopping mechanism 25 similar in function to the stopping mechanism 12 of the infeed section 10. The stopping mechanism 26 generally applies a pressure on the top of a section of board 2 having been processed by the applicator 30. As such, the pressure ensures that the boards 2 remains levelled while pressure of the head 40 is applied on a portion of the board being processed. The stopping mechanism 26 generally comprises a top member 26 and a bottom member 27 allowing the board 2 to move in-between. The top 26 and bottom 27 members broadly act as a press over the board 2. The top member 26 may be embodied as block comprising a friction portion contacting the top portion of the board 2. The bottom portion may be embodied as a friction roll contacting a bottom portion of the board 2. The top 26 and bottom 27 portions are configured to move toward one another when stopping the board 2 and to move away from one another when releasing the board 2.

The outfeed unit 20 may further control output of the processed board 2 to the next station in the production line, such as ensuring that only one board is moved at a time. The outfeed unit 20 may further comprise an actuator 28 controlling the movement of the stopping mechanism 25. Understandably, any other means of stopping displacement of a plank may be used.

Referring back to FIGS. 1A and 1B, the outfeed unit 20 receives processed planks 2 from the filler applicator 30 and releases them from the system 100. A conveyor similar to the conveyor of the infeed unit 10 and/or the putty section 30 may be used to move the planks 2.

The device 100 comprises a filler applicator 30 applying the filler, such as putty, on the board 2 being processed. The filler applicator 30 comprises a head 40 fluidly connected to a filler reservoir. The filler applicator 30 further comprises a pressuring mechanism 80 adapted to maintain a pressure of the head 40 on the top surface of the processed board 2.

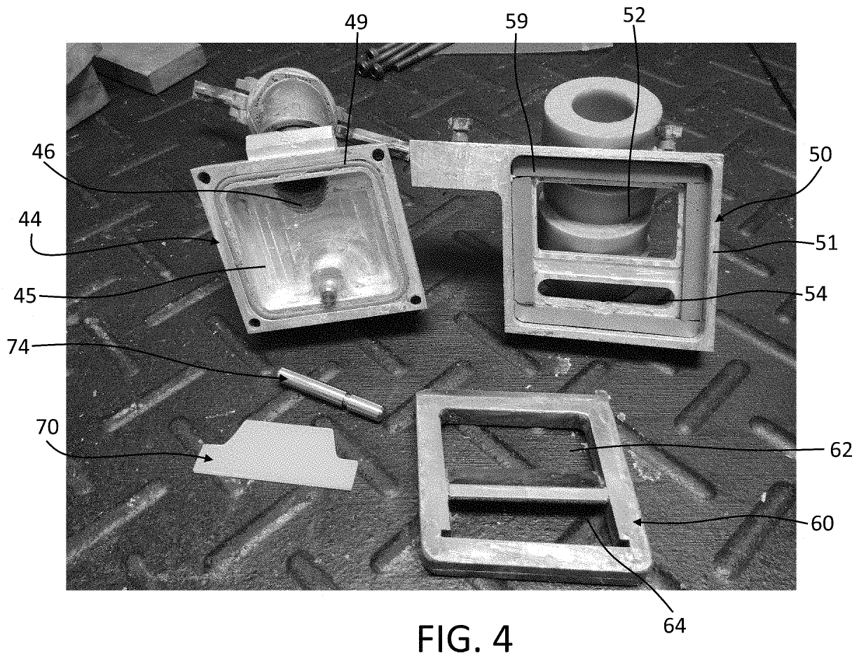

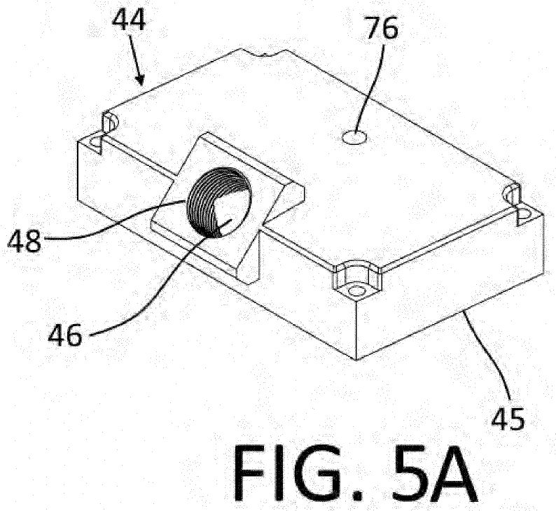

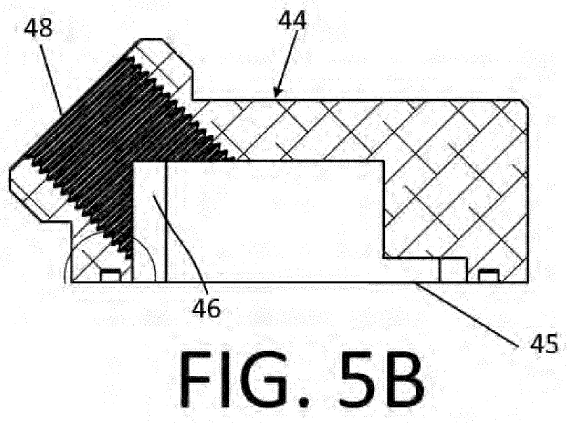

The filler applicator 30 is adapted to apply an even layer of filler on the board 2. Referring to FIGS. 4 to 5B, the head 40 comprises a main body 44 having a filler input port 48 and a filler output port 46. In the illustrated embodiment, the filler input port 48 comprises threads to receive a tube in fluid communication with the filler reservoir. The filler input port 48 of the main body 44 may have a cylindrical shape. Understandably, the filler input port 48 may have any other suitable shape. The main body 44 may be further shaped differently for different dimensions of planks 2. For example, the main body may be smaller for planks of 2″ wherein it may be bigger for planks of 5″.

The filler output port 46 comprises a bottom surface 45 having an aperture. The main body 44 further comprises a cavity or enclosure in communication with the filler input port 48 and the filler output port 46. The filler output port 46 comprises a spreading device 50, such as a fixation plaque. The spreading device 50, shown in FIGS. 4 to 6B, may comprise a first opening 52. The first opening 52 lets the filler exit the head 40 toward the top surface of the board 2. The spreading device 50 may comprise a second opening 54 receiving a knife or blade 70. The knife or blade 70 acts to spread the filler putty applied on the planks 2. The spreading device 50 may further comprise a knife fixation recess 56.

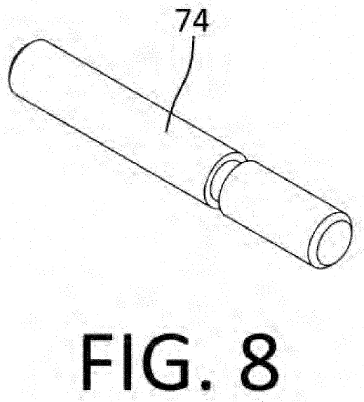

In the illustrated embodiment, the knife fixation recess 56 is adapted to receive the securing pin 74 shown in FIG. 8. The spreading device 50 is typically made of hard material such as steel, hard plastic or aluminum.

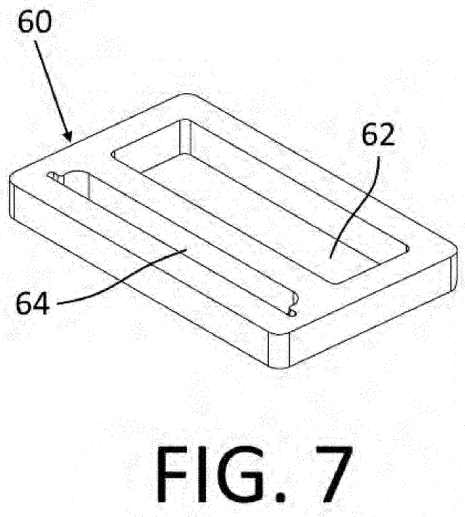

Referring now to FIGS. 4 and 7, the spreading device 50 may further comprise an aperture in its bottom surface 51 in which a lower portion 60 comprising a first opening 62 in fluid communication with the first opening 52 of the spreading device 50 and a second opening 64 in communication with the second opening 54 of the spreading device 50 may be secured. The first opening 62 allows application of the filler on the top surface 3 of the planks 2. The second opening 64 is adapted to receive a lower portion of the knife 70, scrapper or any other means for spreading the filler applied on the planks 2. The bottom surface of the lower portion 60 is in direct contact with the top surface 3 of the planks 2. The lower portion 60 may be made of any material adapted to glide over the top surface 3 of the board 2 while not damaging the said top surface 3. As such, the lower portion may be made of aluminum or hard plastic.

The head unit 40 may further comprise a seal 49 positioned between the bottom portion of the body 44 and a top portion of the spreading device 50. The seal 49 is positioned around or at the perimeter of the inner chamber 45 of the main body 44. The seal 49 generally aims at limiting any overflow of filler outside of the head unit 40.

The bottom portion of the spreading device 50 may further comprise a sealing means 59 adapted to mate with the bottom portion 60 of the head 40. The seal 59 generally prevents filler from spilling between the spreading device 50 and the bottom portion 60. The seals 49, 59 are typically made of rubber but may be made of any other material having sealing properties known in the art.

In some embodiments, the spreading device 50 and the bottom portion 60 may be unitary.

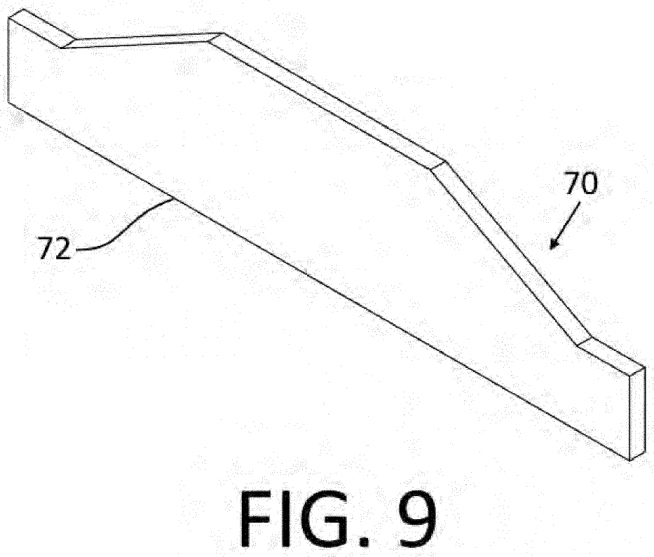

Referring now to FIG. 9, an exemplary knife or scrapper 70 is illustrated. The scrapper 70 generally extends along the width of the bottom portion of the head 40, such as from the bottom of the spreading device 50 or a bottom surface of the bottom portion 60. The scrapper 70 is in contact with the top surface 3 of the planks 2 to spread the filler having exited from the bottom portion of the head 40. In the illustrated embodiment, the filler exits from the first opening 64 of the bottom portion 60. In a preferred embodiment as shown in FIG. 9, the scrapper 70 is a substantially flat panel. The scrapper 70 typically comprises a flat edge 72 for evenly spreading the filler on the top portion 3 of the board 2. Understandably, the scrapper 70 may have any other shape known in the art for spreading a viscous material such as putty, over a generally flat surface. The edge 72 may have a thickness lower or greater than the thickness of other portions of the scrapper 70. The scrapper 70, or at least the edge 72 of the scrapper 70, is made of a material allowing gliding over the top surface while not damaging the said top surface 3 of the board 2.

The scrapper 70 is secured to the head 40. In the illustrated embodiment, the scrapper 70 is inserted in the openings 54, 64 of the spreading device 50 and/or bottom portion 60. In such embodiment, the scrapper 70 is secured to the head using the pin 74 as shown in FIG. 8. Understandably, the fastening pin 74 may be treaded or may be a bolt. Furthermore, any other means know in the art for fastening the scrapper 70 to the head 40 may be used.

In some embodiments, the width of the scrapper 70 may be equal or slightly larger than the width of the processed board 2. The shape and dimensions of the main body 44 and/or the plaques (50, 60) may be adapted to the dimensions of the planks 2 to be processed. For example, the knife opening of the head 40 may have a width adapted to be substantially the same as the width of the planks to be processed, thus allowing an even spread of the filler over the top surface 3.

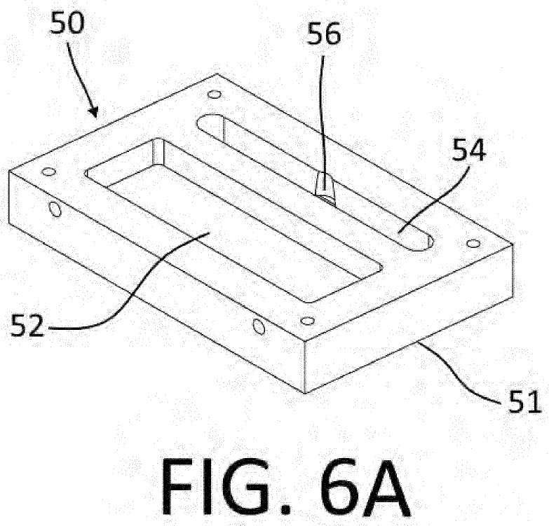

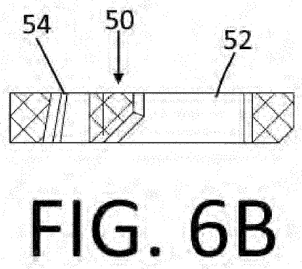

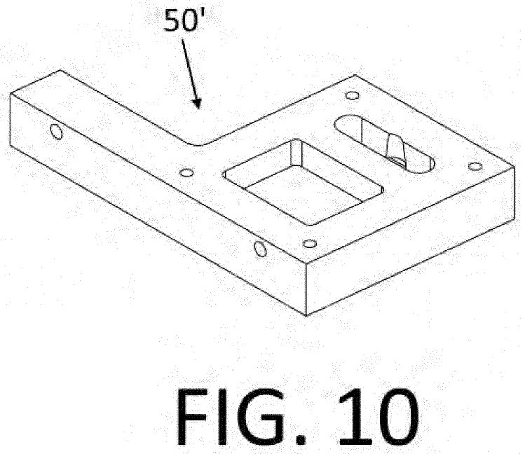

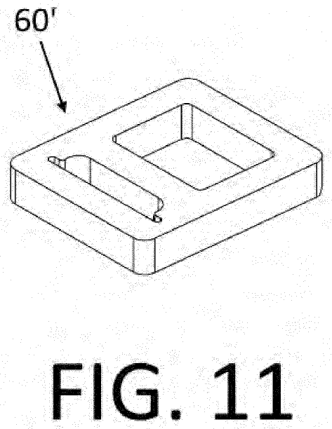

The shape of the spreading device 50 may be varied to be used with boards 2 having different widths. As such, the securing portion of the spreading devices 50 having different dimension may have uniform or standard dimensions to be fitted to the bottom portion of the head 40. For example, the embodied spreading device 50 of FIGS. 6A and 6B is adapted to be spread a filler over a board having a width of 5″. Referring now to FIGS. 10 and 11, the embodied spreading device 50′ and bottom portion 60′ are adapted to spread a filler over a board having a width of 2″. In such example, even if the openings of both embodiments having different dimensions, the spreading devices 50, 50′ may be secured to bottom portion of the same the head 40.

In some further embodiment, the dimensions of the head 40 are adapted to a specific width of a board 2 to be processed. As such, when a production is switched to another width of boards 2, the head unit 40 of the device 100 is changed to another head unit 40 having dimensions fitting the width of the boards of the next production.

Referring back to FIGS. 1B and 1C, an exemplary pressuring mechanism 80 is illustrated. The pressuring mechanism 80 generally applies a constant pressure over the head 40 to maintain the said head 40 in contact with the top surface 3 of the processed plank 2. The pressuring mechanism 80 generally comprises a support frame 82, an actuator 86 and a servomotor 88. The support frame 82 may comprise a support 83 for receiving the actuator 86 and a pressure plate 84 adapted to apply vertical pressure on a top portion of the head 40.

In the illustrated embodiment, the support frame 82 is pivotally attached to the frame of the device 100. As such, when the actuator 86 is extending, the support frame is pushed against the top portion of the head 40. The pressure plate 84 may be embodied as one or more finger pressing on the top portion of the head 40. In the illustrated embodiment, the support 83 comprises a pin attaching a bottom portion of the actuator 86 to the support frame 82. The servomotor 88 is controlling the actuator 86. Typically, the actuator 86 is pushing on the head 40 during operations of the device 100. The pressuring mechanism 80 may be released when the head 40 is changed for another head 40, such as during maintenance or during change of production.

Broadly, the pressuring mechanism 80 shall apply a pressure strong enough to create a counter force to the pressurized filler exiting the bottom portion of the head 40. Accordingly, the constant pressure applied on the head 40 creates a tight seal between the bottom portion of the head 40 and the top surface 3 of the board 2. It may be appreciated that the tight seal prevents the filler from being spread unevenly or uncontrollably on the top surface 3 of the board 2. An equal and controlled application of filler further prevents any overflow from to the side portions of the board 2. Such overflow may decrease the quality of the processed planks 2, may unnecessarily increase usage of filler and may increase maintenance or down times of the device 100.

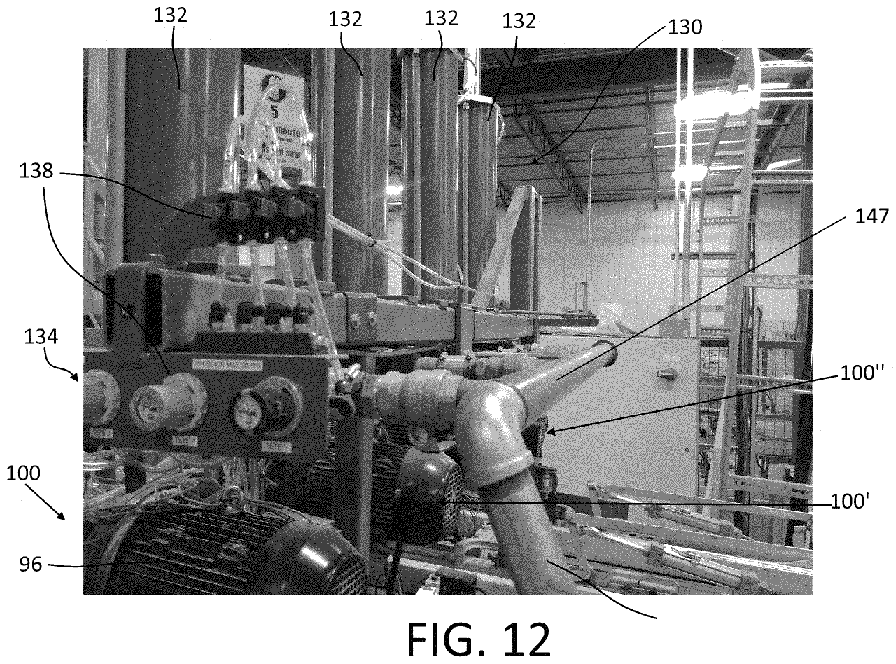

Referring now to FIG. 12, the device 100 may comprises a filler distribution system 130. The filler distribution system 130 generally comprises one or more reservoirs 132 fluidly connected to the head 40. The reservoir 132 may be fluidly connected by a tube 90 (shown in FIGS. 1A and 1B). The tube 90 is adapted to contain the pressurized filler. The reservoir 132 may comprise an inner piston or pressurizing system 134 to maintain a constant pressure of the filler in the head 40. The pressuring system 134 may comprise a mechanical pump, to pressurized the filler within the tube 90 and the head 40. Hence, the pressure of the filler being exhausted from the opening 62 onto the top surface 3 of the planks 2 may be varied depending on the properties of the mechanical pump used.

The filler distribution system 30 may further comprise a pressure monitoring system 138. The pressure monitoring system 138 generally monitors of the pressure present in the head 40 and/or the tube 90. The pressure monitoring system may control or monitor pressure within one or more devices 100, 100′ and 100″ working in parallel.

In some embodiments, one reservoir 132 may supply filler to a plurality of devices 100 or one reservoir 132 may supply only one device 100.

To avoid unwanted spilling or unequal application of filler on the planks 2, a plank 2 shall remain in contact with the opening 62 of the head 40 to maintain a hermetic seal between the head 40 and the top surface 3 of the board 2. Thus, if, for any reason, processing of the board 2 shall be halted or slowed, the said hermetic seal shall remain in effect to avoid any spilling or overflow of the filler. As described above, the board 2 being moved by the conveying system 4 shall preferably have lengthwise extremities as close to one another in order to avoid significant gap of the hermetic seal when processing another board 2. In some embodiments, planks 2 may touch one another when moved from the infeed section 10 to the filler applicator 30.

Once filler has been applied to the top surface 3 of a plank 2, the scrapper 70 secured to the head 40 may spread said filler substantially equally over said top surface 3 during displacement of the plank 2. In a preferred embodiment, the scrapper 70 is disposed at a vertical angle of the top surface 3 of the plank 2 so that the edge 72 of the scrapper 70 is not directly cutting against the plank 2. The described scrapper 70 placement may prevent cutting or debarking of the wood of the processed planks 2 while ensuring that cracks and holes in the planks 2 are properly filled with some filler. The scrapper 70 may further allow the processed top surface 3 of the planks 2 to be leveled and substantially straight.

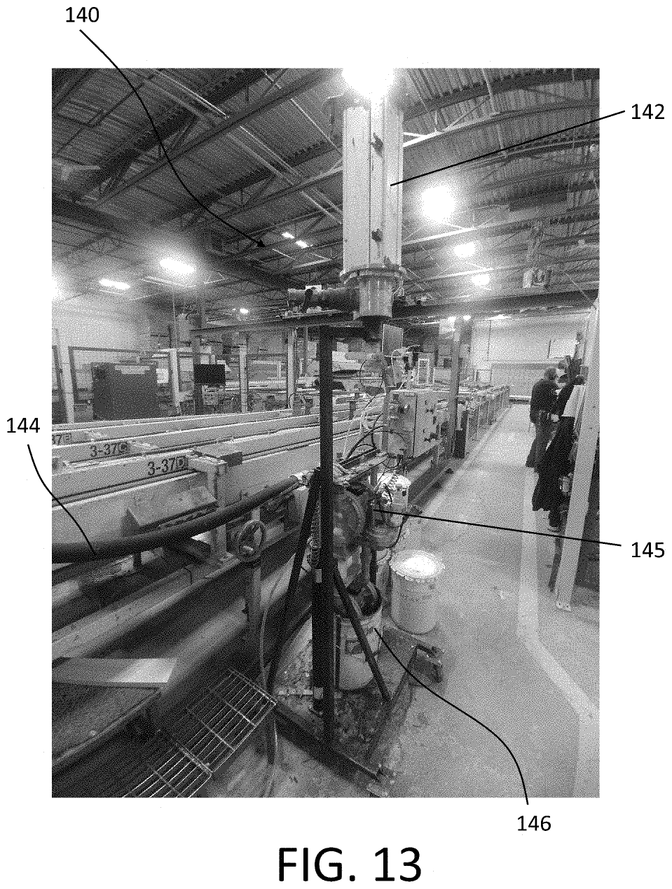

Referring now to FIG. 13, an embodiment of a filler refilling station 140 is illustrated. The refilling station 140 generally allows filling up a reservoir 132 that is empty or having a low level of filler. In the illustrated embodiment, the refilling station 140 comprises a reservoir 142 and an output tube 144. The new filler is loaded into the reservoir 142. The filler present in the reservoir 142 is pumped through the output tube 144 toward a reservoir 132. The refilling station 140 may further comprise a pump 145 which pump filler from new filler barrels 146. The refilling station 140 may further comprise a manifold 147 (see FIG. 12). Adapted to fill a specific reservoir in embodiments having multiple lines of productions or multiple devices.

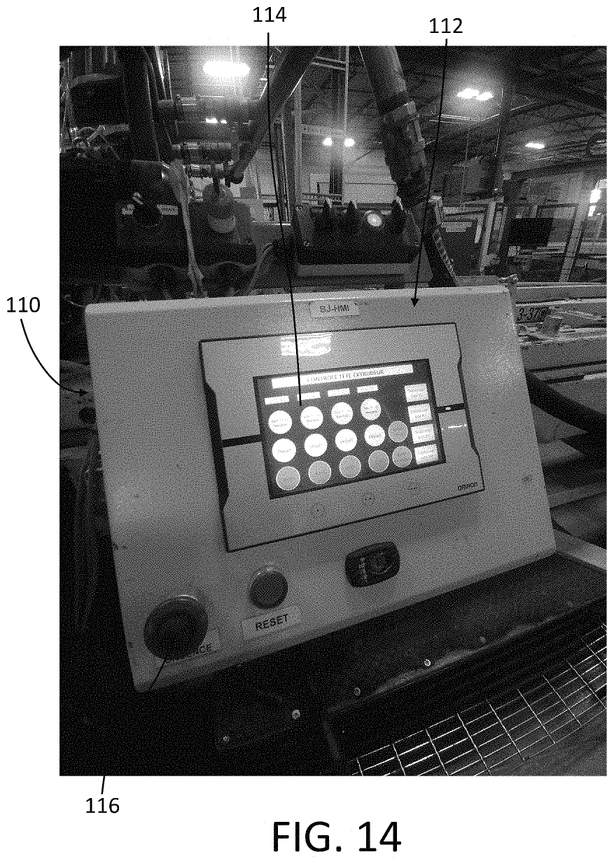

Referring now to FIG. 14, the device 100 may further comprise a control system 110. The control system 110 typically comprise a computerized device and a display device 114. The computerized device 112 may comprise a central processing unit, a memory and a storage device. The computerized device is communication with the servomotors of the device 100 and programmed to control the conveyor system 4, the pressuring system 80, the outfeed unit 20 and/or the infeed unit 10. The control system 110 may further be programmed to control the pressuring system 130 of the device.

In one embodiment, the control system 110 may be programmed to select parameters of the device 100 to which the applicable mechanisms will be configured at. For example, the control system 110 may allow adjusting the pressure within the head 40 over the top surface 3 of the planks 2. In some embodiments, the control system 110 may be programmed to control the size adjusting mechanism 120.

In some embodiments, the display device may be configured to display a graphical user interface (GUI) usable by a user. The display device 114 may be embodied as a touch screen or a typical monitor. The control system 110 may further comprise a physical input button or input device 116 to control the device 100. For example, an urgency stop button located on or next to the device 100 may allow instantly stopping operations of the device 100.

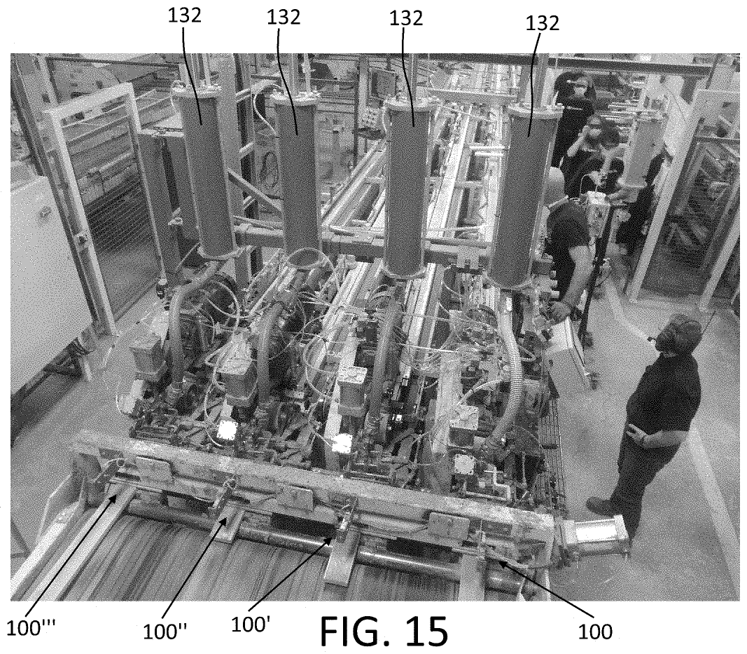

Referring now to FIG. 15, a plurality of devices 100, 100′, 100″ and 100″′ working in parallel are illustrated. It may be appreciated that each of the devices 100 comprises a distinct reservoir 132 located above each of said devices 100. Understandably, each of the reservoirs 132 may be controlled and/or monitored using a single pressuring system 134. In yet other embodiment, each device 100 may be controlled using a distinct pressuring system 134.

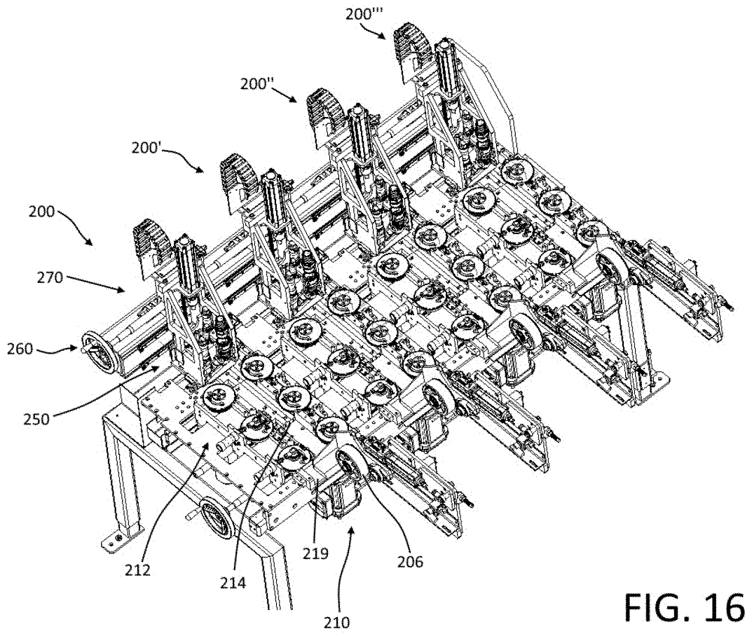

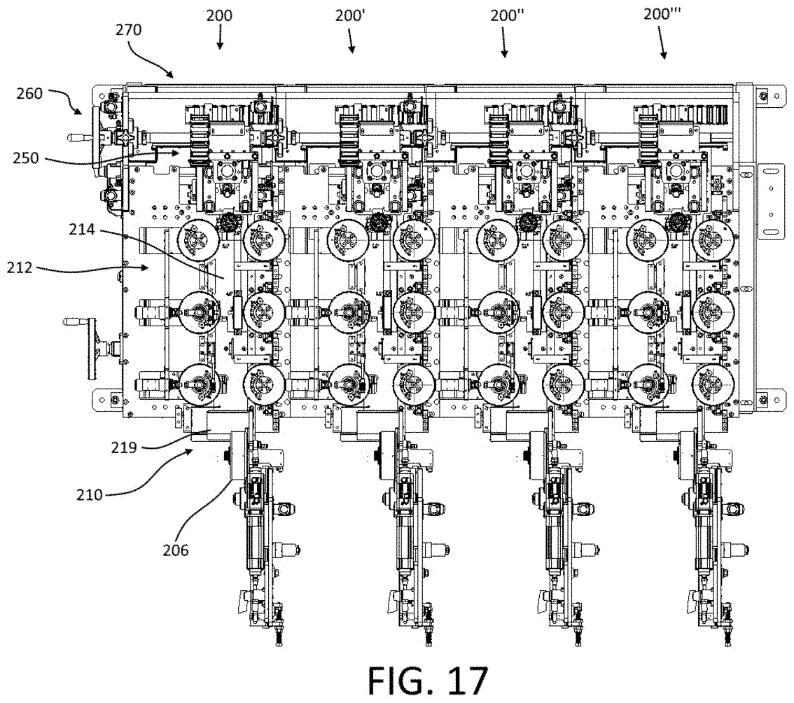

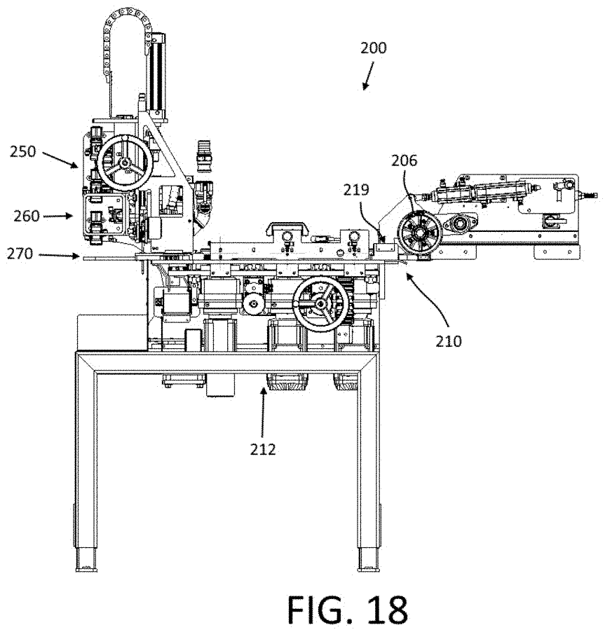

Referring now to FIGS. 16 to 20, a second embodiment of an automatic wood flooring boards reparation device 200 is illustrated. The reparation device 200, similarly to previously presented embodiment of the device 100, comprises an infeed portion 210, a control section 212, a filler applicator 250 and an outfeed portion 270. The device 200 may further comprise any one of the above-described elements of the device 100 unless it may be replaced with one of the below-described elements.

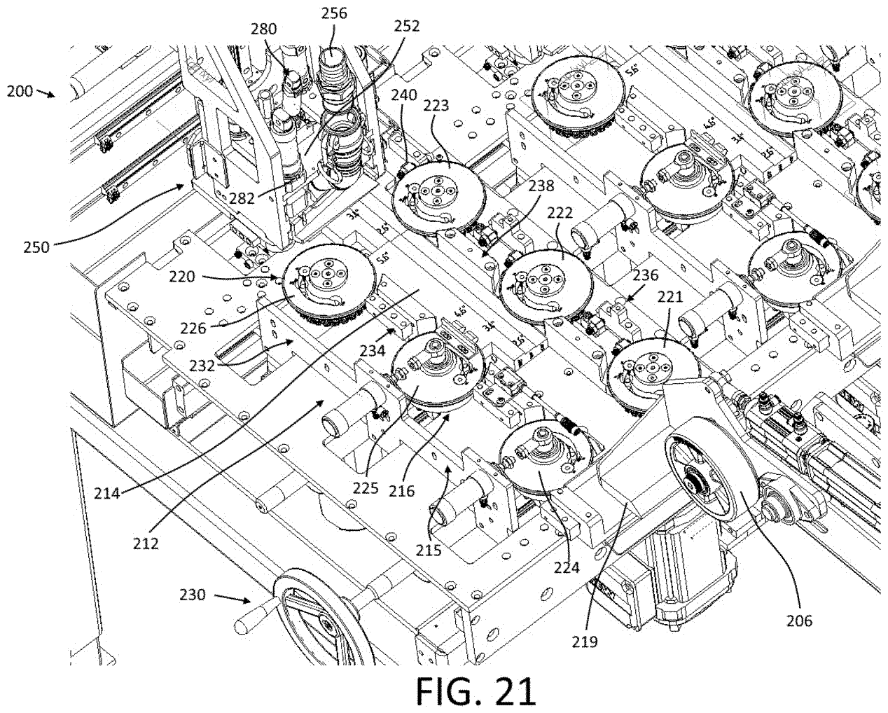

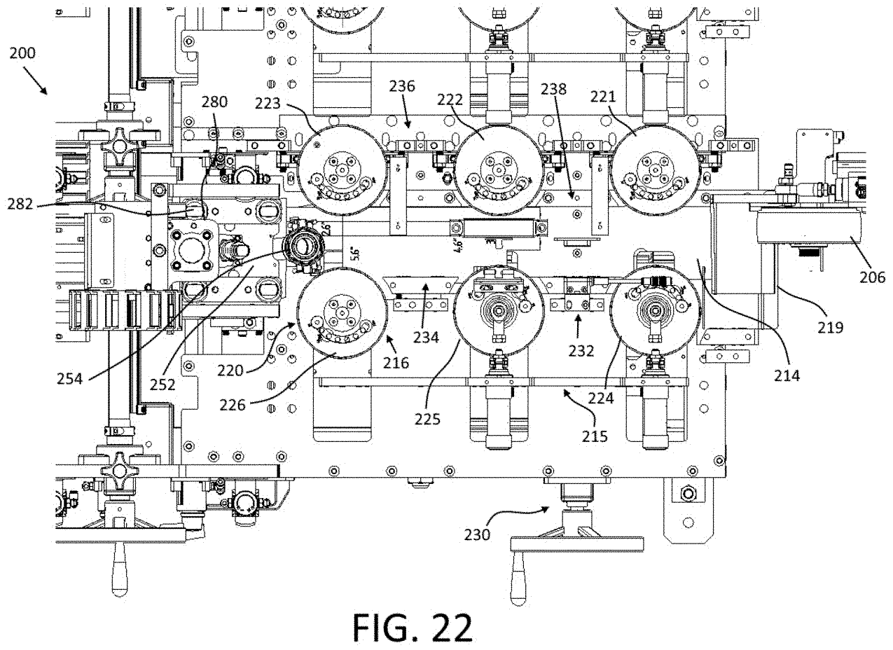

Referring now to FIGS. 21 and 22, the infeed portion 210 of the device 200 may be connected to any type of conveying system (not shown) to receive planks 2. The infeed portion 210 may comprise a top roller 206 pivotally mounted to a frame of the infeed portion 210. generally adapted to feed planks 2 to the infeed portion 210 or to other components of the device 200. The top roller 206 may be positioned to contact a top surface of a plank 2. In use, when the top roller 206 is activated, a plank 2 positioned under the top roller 206 is displaced due to friction with the outer surface of the roller 206.

The infeed portion 210 may further comprise a slider 219. The slider 219 is typically adjacent to the top roller 206, either upstream or downstream of the planks 2 being moved in the infeed portion 210. The slider 219 generally prevents the moving plank 2 to move upwardly from the conveying means. The slider 219 may further vertically orient the plank 2 in-line with the downstream components of the device 200. Understandably, the slider 219 may have any shape preventing passage of planks 2 over a certain predetermined height. As such, the slider 219 may vary the allowed height of a plank 2 based on the operational requirements. Additionally, the slider 219 may be configured to be lowered or be risen on top or in front of a plank 2 to stop or allow passage of such plank 2. In such an embodiment, the slider 219 may be operatively connected to an actuator, not shown, controlling the lowering and/or raising of the said slider 219.

Further in the infeed portion 210 may further comprises a feed controller 212. The feed controller 212 generally controls the feeding of planks 2 to the filler applicator 250. The feed controller 212 may comprise a bottom surface 214 for supporting planks 2. The bottom surface 214 may be made of material having a low friction coefficient to allow substantially unobstructed sliding of the planks 2 over the bottom surface 214. The length of the bottom surface 214 may simultaneously support a plurality of planks 2 arranged in series along their length.

The infeed portion 210 may further comprise a displacement mechanism 216. The displacement mechanism generally moves the planks 2 along the feed controller 212. The displacement mechanism 216 may comprise a plurality of wheels 220, generally disposed in series on both sides of the bottom surface 214. In operation, the wheels 220 contacts both longitudinal walls of the moving planks 2. In the illustrated embodiment, the displacement mechanism 216 comprises two sets of three wheels (221, 222, 223 and 224, 225, 226). A first set of wheels (221, 222, 223) are pivotally attached on a first side of the bottom surface 214. A second set of wheels (224, 225, 226) are pivotally attached to a moveable portion 215 of the bottom surface 214. The wheels 220 are configured as pairs which are facing one and the other. Accordingly, and as illustrated, the wheels may be operated as follows (221 with 224, 222 with 225 and 223 with 226).

In the illustrated embodiments, the wheels 224, 225, 226 are idling wheels while some or all of the wheels 221, 222, 223 are drive wheels. As illustrated, the wheels 221 and 222 are drive wheels and the wheel 223 is an idling wheel. The first pair of wheels (221,224) comprises one drive wheel 224 and an idling wheel 221. The second pair of wheels (222,225) may comprise one drive wheel 222 and one idling wheel 225. The third pair of wheels (223, 226) may comprise of one drive wheel 223 and one idling wheel 226.

Understandably, any combination of idling wheel and drive wheels 220 may be used within the scope of the present invention. One skilled in the art shall also understand that more wheels may be added or less wheels may be pivotally attached to the bottom portion 214 within the scope of the present invention. In some embodiments, each pair of wheels 220 may comprise an idling wheel and a drive wheel. Having multiple drive wheels typically limits the chances of a plank 2 not being in contact with one of the said drive wheels. It may further be understood that the wheels 220 may be replaced by any other displacement mechanism having similar functions, such as conveying chains.

The drive wheels are operatively connected to a motor or servo-motor which is connected to the controller. As discussed above, the motor or servo-motor is typically positioned under a section of the bottom surface 214 which is fixed (not moving).

In use, the displacement mechanism 216 typically receives a plank 2 from the top roller 206 and/or from slider 219, the plank 2 gliding on the bottom surface 214. The plank 2 may be moved over the bottom surface 214 towards the filler applicator 250 upon activation of the motor connected to the drive wheels.

As an example, the periphery of each of the first pair of wheels (221 and 224) first receive a portion of the plank 2. The rotation of the drive wheel 221 and the friction against the side wall of the plank 2 control the displacement of the said plank 2. The same portion of the plank 2 is then moved between the second pair of wheels (222 and 225) which also control the displacement of the said plank 2 upon actuation of the drive wheel 222. In such use, the drive wheel 222 guides movement of the plank 2 and promotes efficient displacement of the plank 2 upon actuation of the actuated wheel 222. The same principle generally applies to the third pair of wheels (223 and 226). The same process is repeated to other portions of the plank 2 to move the said plank 2 towards the filler applicator 250.

The outer surface of the wheels 220 are typically made of a friction material for moving the side walls of the planks 2.

Understandably, any type of drive and idling wheels may be used within the scope of the present invention. In the illustrated embodiment, each of the idling wheels (223, 224, 225 and 226) typically comprise a substantially cylindrical body having a substantially smooth peripherical surface to create friction with the sidewall of the plank 2. Each of the illustrated drive wheels (221 and 222) comprises a cylindrical body having a periphery allowing traction of the sidewall of the plank 2.

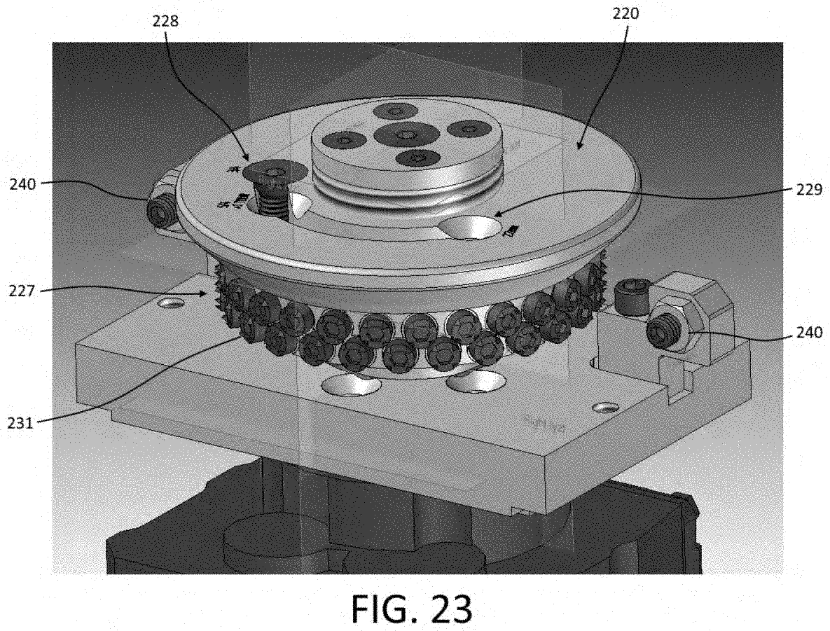

Referring now to FIG. 23, an embodiment of a drive wheel is illustrated. In such embodiment, the drive wheel comprises a gripping surface or means 227. The gripping surface 227 may comprise a plurality of screw heads dispersed along the said gripping surface 227. In such an embodiment, the screw head comprises a rough top surface 231. More specifically, in the illustrated embodiment, the top surface 231 is concave.

Understandably, the top surface 231 may have any other shape and size suitable to create traction on the sidewall of the plank 2. As discussed above, the gripping surface 227 is generally located at the periphery of the body of the drive wheel to allow gripping of the side surface of the planks 2.

The top surface of the wheel may comprise a height adjustment system 228 to raise or lower the height of the wheel 220. As such, the system may be adjusted to receive a wide array of plank 2 heights. In the illustrated embodiment, the height adjustment mechanism is a screw 228. The screwing and unscrewing of the height screw 228 generally allow varying height of the wheel 220, or more specifically of the height of the cylindrical body of the wheel 220. In the illustrated embodiment, when the height screw 228 is unscrewed but not fully removed from the wheel 220, the wheel 220 may be turned with the height screw 228 within a slit guide 229. The length of the slit guide 229 may correspond to the raising or lowering of the wheel 220 between two predetermined heights of planks 2. In such embodiment, the wheel 220 may be threadingly received by the frame of the control portion 212 to allow the said height adjustment. The slit guide 229 may therefore help users to quickly and easily screw or unscrew the wheel 220 to correspond to predetermined height of planks 2. It may be appreciated that the height screw 228 may be applied to any of the wheels 220 of the device 200, and is not limited to the actuated wheels. Understandably, any other type of wheel height adjustment system 228 may be used within the scope of the present invention.

Depending on the length of the plank 2 moving along the displacement system 216. As such a gap may exist between two adjacent planks 2 when the operation of the device 200 has been stopped. As such, in some embodiments, the controller is configured to activate one drive wheel at a time. As such, the controller may activate a first drive wheel in contact with a first plank 2 for a predetermined period of time and activate a second drive wheel in contact with a second plank forward to the first plank 2 following the said predetermined period of the time. As such, the first plank is moved toward the second plank to close the gap. The delayed activation of the drive wheels 220 of the different pairs may allow closing of the possible gaps to prevent unwanted buildup of putty between two planks 2 during the application of putty in the filler applicator 250.

Referring back to FIGS. 21 and 22, the displacement system 216 may comprise a width adjustment system 230. The illustrated width adjustment system 230 comprises a portion 232 movable with regard to the bottom surface 214 to adjust the width between the wheels 220. To adjust the width, a movable section 232 of the displacement system 216 generally comprises idling wheels (224, 225, 226) and a side walls 234. The movable section 232 may be displaced towards or away from a fixed side section 236. The fixed side section 236 comprises a drive wheel or a combination of drive and idling wheels (221, 222, 223) and a side walls portion 238. The width adjustment mechanism 230 may comprise a mechanism, such as one or more actuators or an endless screw, connected to the side section 232 and for laterally displacing the said side section 232. In the illustrated embodiment, the side section 232 is moved by rotating a hand wheel located on the side of the device 200. Understandably, any other known mechanisms or means to move the side section 232 with regard to fixed side section 236 may be used.

In some embodiments, the feeder 210 may comprise one or more sensing devices 240, such as sensors. The sensing devices 240 may be positioned at various locations along the length of the displacement system 216. The sensors 240 are in communication with the controller to detect the presence of planks 2 at specific locations. The controller may be programmed or configured to use the signals received from the sensors 240 to determine which wheels 220 to activate and to determine the duration of the activation. In some embodiments, the sensors 240 may be located at next to each of the wheels 220, and/or at each extremity of displacement system 216 or feeder 210.

The filler applicator 250 is located downstream of the infeed portion 210, and namely of the displacement system 216. The filler applicator 250 is also referred to as the putty section. The filler applicator 250 is configured to apply and spread putty (also referred as filler) over a top surface of the planks 2. In the illustrated embodiment, the filler applicator 250 comprises a head 252 adapted to receive putty from a reservoir 132. A pressure is applied on the head 252 against a top surface of the moving plank 2. The applied pressure creates a pressurized chamber between the head 252 and the top of the plank 2. As the plank 2 moves, a layer of putty is applied on the top surface of the plank 2, thus covering imperfections that may be present on the said plank 2. The head 252 may comprise a plurality of putty output ports 254 exhausting putty at different locations over the horizontal area of the head 252.

The putty output ports 254 may each be in fluid communication with a respective tube 256 of putty. Each of the tubes 256 generally act as a liaison between the reservoir 132 and the output ports 254. In the shown embodiment, the head 252 comprises four putty output ports 254. Each of the putty output ports 254 may be located at different corners of the bottom portion of the filler applicator head 252. The location of the putty output ports 254 at each corner of the head 252 generally promotes efficient and even spreading of putty of the planks 2 top surface. Understandably, the head 252 may comprise any number of putty output ports 254 and corresponding tubes 256 connected to the reservoir 132. Furthermore, the output ports 254 may be disposed at any locations on the bottom portion of the head 252.

The system 200 may also comprise a pressuring mechanism 280 for maintaining a constant pressure of the filler applicator 250 over the top surface of the wood board 2. The pressuring mechanism 280 comprising a plurality of pressure cylinders or pistons 282. The pressure cylinders 282 may be pressed on one or more locations on the head 252 of the filler applicator 250. The multiple points of pressure allow applying a substantially even pressure over the top surface of the planks 2. As an example, the embodied filler applicator 250 comprises five pressure cylinders 282, a first centrally located and four distributed at each of the corners of the head 252. Understandably, the pressuring mechanism 280 may comprise any number of pressure cylinders 282. The pressuring mechanism 280 may be in communication with the pressuring system 134 to control the pressure applied by the head 252 on the planks 2.

In a further embodiment, there may be more than one reservoir 132 providing putty to the filler applicator 250. The filler applicator 250 may further be embodied as disclosed above in the other embodiments pf the present invention.

In yet another embodiment of the invention, the filler applicator 250 may be in an operative or in an inoperative mode. In the operative mode, the head 252 of the filler applicator 250 may be at a predetermined height to apply putty of the planks 2. An activation means, such as a button on the computerized device 112 or a physical switch, button, hand wheel or the like on the device 200, may activate the inoperative mode and vice-versa. In the inoperative mode, the head 252 of the filler applicator 250 may be raised by a predetermined distance to provide free space under the filler applicator 250. As an example, the raised head 252 may allow removing a plank 2 that would be stuck or otherwise trapped under the filler applicator 250 or at any location in the system. As an example, the head 252 may be raised by about forty to fifty centimeters in inoperative mode.

Referring back to FIGS. 16 to 20, the system may comprise a lateral displacement system 260. In such an embodiment, the filler applicator 250 of the device 200 is attached to the lateral displacement system 260. The lateral displacement system 260 may be embodied as a rail system or a system using an endless screw. In use, when the lateral displacement system 260 is activated, the filler applicator 250 is laterally moved on either side of the length of the device 200. It may be appreciated that a second filler applicator 250 may be attached to the lateral displacement system 260, not shown. The second filler applicator 250 is typically parallel to the first filler applicator 250. As such, when the lateral displacement system 260 is activated, the first filler applicator 250 may be replaced with the second filler applicator 250. In a typical use, the second filler applicator 250 has a different width than the first filler applicator 250. As such, prior to processing planks 2 having a different width, the second filler applicators 250 is moved into operation and the process may thus be quickly restarted.

As such, a method to process a different length of plank is provided. The method comprises releasing pressure in the conduit of putty, rising the filler applicator 250 from the top of the plank, changing the head 252 of the filler applicator 250 to the new width, and varying the width of the displacement mechanism 216 to the new width. The change of head 252 may comprise activating a lateral displacement system 260 to use a second filler applicator 250 having the required width. The variation of the width of the displacement system 216 may further comprise moving a movable portion 232 of the displacement system 216 toward or away from a fixed portion of the displacement system 216 to adapt to the new width. The movement of the movable portion 232 may be performed using an actuator or using manually operated system.

Still referring to FIGS. 16 to 20, a plurality of devices (200, 200′, 200″, 200″′) may be disposed as different lines of production, typically being parallel one to another. Although there are four devices 200 illustrated, other embodiments may comprise any number of machines or devices 200 positioned in parallel. It may be appreciated that each of the devices 200, 200′, 200″, 200′″ may comprise a distinct reservoir 132 located above each of said devices 200, not shown. Understandably, each of the reservoirs 132 may be controlled and/or monitored using a single pressuring system 134. In yet other embodiment, each device 200 may be controlled using a distinct pressuring system 134. It may further be appreciated that a single lateral displacement system 260 may be in use for each of the devices 200 and that the devices 200 may accordingly exchange filler applicators 250 between adjacent devices 200.

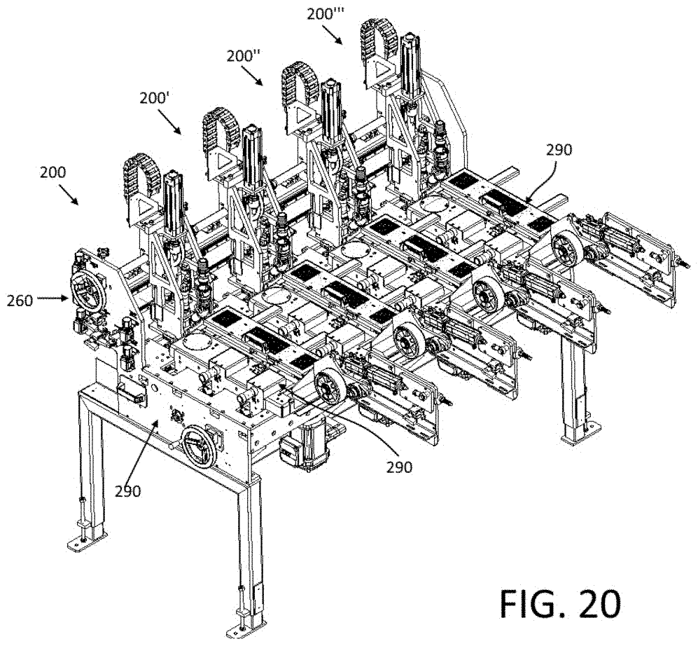

Referring to FIG. 20, the device 200 may comprise covers 290 configured to protect and/or hide the elements of the same. For example, the covers 290 may cover the elements of the control section 212 such as the movable 232 and fixed 238 portions.

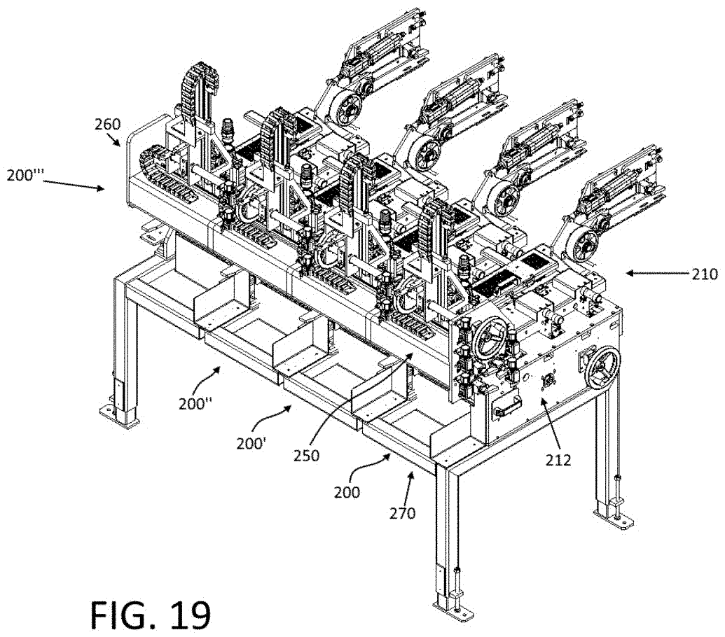

Referring to FIGS. 19 and 20, an outfeed section 270 may be comprised at the outfeed of the filler applicator 250. The outfeed section 270 may receive planks 2 having a top surface covered by spread putty and may retain or displace said planks 2 away from the device 200. The outfeed system 270 may comprise a retainer member to ensure that the processed plank 2 remains leveled with the filler applicator 250 to the said filler applicator 250 to lose the sealed chamber between the head 252 and the top of the plank 2.

A method of applying filler on a board is further provided. The method generally comprises the steps of displacing a board from a first to a second location, applying a pressurized filler on a top surface of a board through a hermetic aperture in sealed contact with the said top surface of the board 2. The method may further comprise scrapping excess of filler applied on the top surface of the board. The method may further comprise controlling movement of the board to maintain the hermetic seal of the filler over the top surface of the board 2 being processed.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An automatic wood boards reparation system, comprising:
a filler applicator to be pressed against a top surface of a wood board being conveyed, the filler applicator being in fluid communication with a source of pressurized filler to create a sealed chamber between the top surface of the wood board and a bottom portion of the filler applicator, the filler applicator comprising an opening to spread a layer of the pressurized filler on the top surface of the wood board; and
a conveying system to move the wood board toward and away from the filler applicator.

2. The system of claim 1, comprising a leveling system to maintain the processed wood board leveled with the bottom portion of the filler applicator.

3. The system of claim 2, the leveling system comprising a top roller rotatable over the top surface of the board.

4. The system of claim 2, the leveling system comprising a slider to maintain the top surface of the board leveled with the bottom portion of the filler applicator.

5. The system of claim 1, the conveying system comprising a board displacement system limiting gaps between extremities of wood boards fed to the filler applicator.

6. The system of claim 5, the board displacement system comprising at least two pairs of laterally opposing wheels adapted to contact sidewalls of the wood boards to be processed, the upstream pair of wheels being configured to drive a first wood board toward a second wood board immobilized by the downstream pair of wheels.

7. The system of claim 6, one of each of the at least two pairs of laterally opposing wheels comprising a drive wheel.

8. The system of claim 6, the wheels comprising a friction surface in contact with sidewards of the wood boards.

9. The system of claim 8, the friction surface being a gripping surface.

10. The system of claim 9, the gripping surface comprising a plurality of screw heads.

11. The system of claim 1, the conveying system comprising a width adjustment system.

12. The system of claim 11, the width adjustment system comprising a side portion comprising a side wall laterally movable toward a fixed portion comprising a side wall.

13. The system of claim 1, the conveying system comprising a height adjustment system.

14. The system of claim 13, the height adjustment system having the wheels being treaded and attached to a base surface, the wheels being configured to change in height when screwed or unscrewed.

15. The system of claim 1, comprising a second filler applicator having a different width than the first filler applicator.

16. The system of claim 1, further comprising a pressure application system adapted to apply pressure on the filler applicator against the top surface of the wood board.

17. The system of claim 16, the pressure application system comprising a cylinder at each corner of a top portion of the filler applicator to apply a constant pressure over the top surface of the wood board.

18. The system of claim 1, comprising a plurality of sensors connected to a controller for detecting presence of wood board, the controller being configure to feed the wood board based on signals of the sensors.

19. A method for repairing a top surface of wood boards comprising:
conveying the wood board;
pressing a filler applicator against the top surface of the wood board being conveyed;
spreading a layer of pressurized filler over the top surface of the wood board through an aperture of a bottom surface of the filler applicator.

20. The method of claim 19, further comprising maintaining the conveyed wood board leveled with the bottom portion of the filler applicator.

21. The method of claim 19, further comprising closing gaps between two extremities of conveyed wood boards.

22. The method of claim 19, further comprising applying pressure at different locations on a top portion of the filler applicator to maintain a constant pressure of the filler applicator over the top surface of the conveyed wood boards.
